(19) United States
(12) Patent Application Publication
(10) Pub. No.: US 2008/0077568 A1
(43) Pub. Date: Mar. 27, 2008

(54) TALENT IDENTIFICATION SYSTEM AND METHOD

(75) Inventor: Edward Stanley Ott, Palo Alto, CA (US)

Correspondence Address: YAHOO! INC. C/O GREENBERG TRAURIG, LLP, MET LIFE BUILDING, 200 PARK AVENUE, NEW YORK, NY, 10166, US

(73) Assignee: Yahoo! Inc., Sunnyvale, CA (US)

(21) Appl. No.: 11/535,248

(22) Filed: Sep. 26, 2006

(51) Int. Cl. G06F 17/30

(52) U.S. Cl. 707/5

(57) ABSTRACT

Systems and methods are disclosed for automatically identifying talent from quality and popularity data available on a computing network. The computing network is monitored and new content items and their associated publishers are identified. In addition, quality and popularity data associated with each content item are retrieved from one or more locations on the network. The quality and popularity data are then analyzed to identify popular content items within a particular scope and create a popularity measure of each content item. The popularity measure of each content item is then used to create a popularity measure of each publisher.

### BACKGROUND

The ability to identify new and rising authors and creators of media content, be that content traditional literary, musical, or artistic content such as books, articles, songs, plays, movies, fine art or photographic images, or newly created forms of content such as weblogs, video games, music samples, ringtones, websites, descriptive terms such as tags or keywords, or digital ratings and reviews, can be valuable in present society. Some of these authors will become popular cultural icons and could potentially reach a wider audience that ever before. Corporations that seek mass market exposure are constantly looking for such new talent as a means for advancing their brand recognition or to entice that talent into some other commercial relationship at an early stage in their careers.

Traditionally, authors, performers and creators of original content, collectively referred to as talent, were “found” by commercial interests through a labor intensive process in which a skilled talent scout would experience or otherwise screen the content, e.g., read the manuscript, listen to the musician, watch the movie, view the art, etc., and then make a decision as to the likelihood of the author becoming popular or successful based on a subjective assessment of the quality of the content. Based on this decision, the talent would be retained or not by the commercial interests employing the talent scout.

This method of identifying talent has been heavily criticized because of its slowness, its inefficiency and its reliance on the subjective analysis of a relatively small number of imperfect talent scouts. Another criticism of the method is that often only those selected by the talent scouts are actually exposed to the mass market and therefore have the opportunity to become extremely popular. Thus, the argument is often made that to be a successful artist it is more important to be popular with critics (i.e., the talent scouts) than with people.

However, more content by more authors than ever before is being published electronically via the Internet and are thus being exposed to a potentially mass audience before being vetted by talent scouts, critics or other traditional gatekeepers to the mass market. The traditional methods of identifying new talent, such as manual peer review and selection, are not capable of, nor efficient for, screening the drastically increased amount of content now available. Timeliness of talent identification has also become an important issue with the speed of the Internet allowing new authors to become popular very quickly.

### SUMMARY

Against this backdrop systems and methods have been developed for automatically identifying talent from quality and popularity data available on a computing network. The computing network is monitored and new content items and their associated publishers are identified. In addition, quality and popularity data associated with each content item are retrieved from one or more locations on the network. The quality and popularity data are then analyzed to identify popular content items within a particular scope and create a popularity measure of each content item. The popularity measure of each content item is then used to create a popularity measure of each publisher.

In one aspect, a method for identifying talent is disclosed. The method includes identifying at least one content item associated with a publisher and retrieving first data indicative of the quality of each content item. Second data indicative of the popularity of each content item is also retrieved. The publisher is then ranked based on the first data and the second data of each content item and, based on the results of the ranking operation, the publisher is identified as talent by the system.

In another aspect, a system for identifying publishers is disclosed. The system includes a popularity data collection module adapted to access popularity data on a computing network, in which the popularity data includes data indicative of the popularity of a content item. The system also includes a quality data collection module adapted to access quality data on the computing network, in which the quality data includes data indicative of the quality of the content item. An analysis module is provided that is adapted to generate a content item velocity based on the popularity data and the quality data.

In yet another aspect, a method of selecting a first publisher from a group of publishers of content items within a scope is disclosed. The method includes collecting first data indicative of the popularity of the content items, in which the first data collected from one or more locations on a network. The method further includes identifying the first data associated with content items for each one of the group of publishers. The method further includes analyzing the first data for each one of the group of publishers to generate results indicative of the relative popularity of each one of the group of publishers and selecting, based on the results, the first publisher.

These and various other features as well as advantages will be apparent from a reading of the following detailed description and a review of the associated drawings. Additional features are set forth in the description which follows, and in part will be apparent from the description, or may be learned by practice of the described embodiments. The benefits and features will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The following drawing figures, which form a part of this application, are illustrative of embodiments systems and methods described below and are not meant to limit the scope of the invention in any manner, which scope shall be based on the claims appended hereto.

FIG. 1 illustrates a flowchart of the high-level operations of method for identifying leading publishers of content.

FIG. 2 illustrates an embodiment of a method for automatically obtaining publisher data from a network such as the Internet.

FIG. 3 illustrates one embodiment of a publisher data scheme that may be used in a talent identification system.

FIG. 4 illustrates an embodiment of a method of analyzing a pool of publisher data for a group of publishers to identify talent within a scope.

FIG. 5 illustrates a functional block diagram of a system for identifying leading publishers of content.

FIG. 6 illustrates another embodiment of method for automatically identifying talent.

### DETAILED DESCRIPTION

For the purposes of this disclosure, the term “content” is used broadly to encompass any product type or category of creative work including any work that is in an electronic form that is renderable, experienceable, retrievable, computer-readable filed and/or stored on media, either singly or collectively. Individual items of content include songs, tracks, pictures, images, movies, articles, books, ratings, reviews, descriptive tags, or computer-readable files, however, the use of any one term is not to be considered limiting as the concepts features and functions described herein are generally intended to apply to any work that may be experienced by a user, whether aurally, visually or otherwise, in any manner now known or to become known. Further, the term content includes all types of media content such as audio and video and products embodying the same. As mentioned above, while there are many digital forms and standards for audio, video, digital or analog media data and content, embodiments of the systems and methods described herein may be equally adapted to any format or standard now known or to become known.

Additionally, the terms “publisher” and “talent” refer to identifiable entities such as people, groups of people, or legal entities such as partnerships and corporations who create and/or distribute any form of content. Examples of publishers and talent include a creator of a playlist of songs within a genre (e.g., the “Greatest Bluegrass Songs to Dance To”), an author of a book, weblog or website (e.g., Patently Obvious), an actual publisher of a book (e.g., Chivalry Bookshelf), a reviewer or publisher providing reviews of local interests such as restaurants (e.g., the magazine “5280” covering the Denver market for reviews local attractions), a producer of family-friendly movies (e.g., Pixar) or a landscape photographer (e.g., Ansel Adams). The term publisher was chosen instead of “author” to express to the reader that, in some cases, the mere acts of selection or distribution of prior works typically involves the creation of some form of new content (a playlist, a review, a rating, a website, a series of book titles or movies, etc.) that is directly associated with the publisher in some way. In addition, while it is understood that in many, if not most, cases the publisher may in fact be an author of some form of content under copyright law, by using the term publisher the reader is reminded that authorship is not a requirement.

Talent, on the other hand, refers to those leading publishers who are popular, successful, or likely to become so, because of the quality, popularity, utility or timeliness of the content they create. Thus, talent refers to a specific subset of publishers that are of interest to marketers, distributors and corporate interests.

Embodiments of the disclosed systems and methods include a method for identifying publishers of content, monitoring the popularity of the content over time and identifying leading publishers that are likely to become more popular in the future based on the trends of popularity of the publishers' content items. The systems and methods are further adapted to identify leading publishers within specific market segments, such as movie reviews, reviews specific to a geographic region, or music playlists.

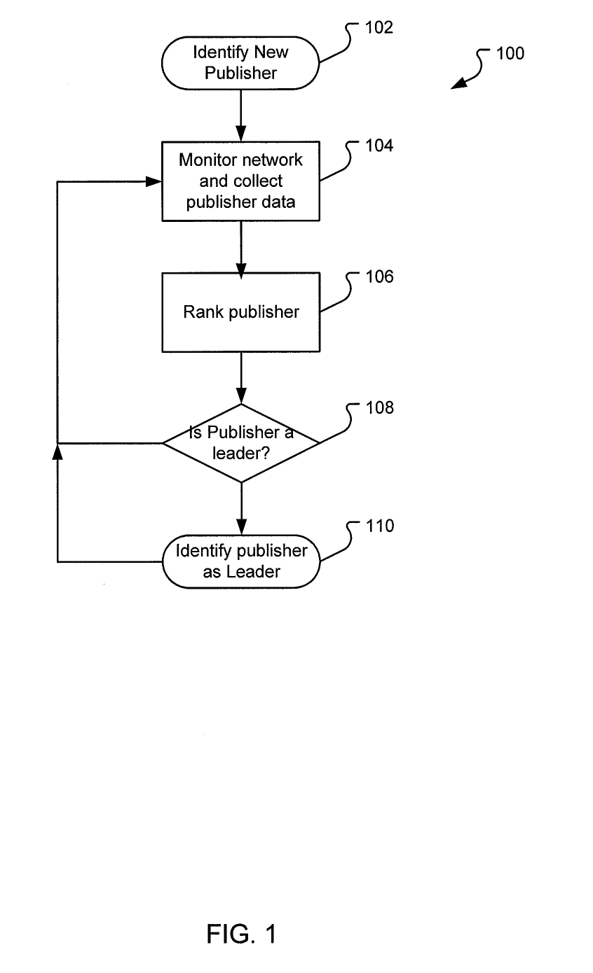

FIG. 1 illustrates a flowchart of the high-level operations of method for identifying leading publishers of content. In the embodiment of the method 100 shown, the method 100 starts when a new publisher is identified in an identification operation 102. In the identification operation 102, a publisher will be identified the first time a content item attributable to the publisher is encountered by the publisher identification system. In an embodiment, this may occur the first time a content item is indexed by the publisher identification system as part of the publisher identification system's active searching of the Internet for new content items. In an alternative embodiment, the publisher identification system may be alerted to a new publisher as part of a publication process, such as a process in which the content item attributable to the publisher is presented to or registered with the publisher identification system by the publisher.

After a new publisher has been identified, in the broadest sense the publisher identification system then collects and monitors publisher data in an ongoing data collection operation 104. Publisher data, as used herein, are data related to individual content items associated with one or more publishers (noting that more than one publisher may be associated with a given content item, for example a playlist may be associated with a first publisher and a each song within the playlist may be associated with their own publishers).

In an embodiment, publisher data may be considered to include data useful for tracking different characteristics of the content items and publishers, each of which being used as a different metric for evaluating a publisher by the system. For example, one characteristic is that of the quality of the content item and ratings information may be used in the system as a metric to quantify this characteristic.

Another characteristic that may be of interest includes the popularity, and more importantly the popularity trend, of a content item or publisher. The popularity may be tracked by metrics that include such data as the number of downloads, sales data, number of mentions in the media, etc. For example, one possible type of data that could be used as a popularity metric or as part of a more complicated popularity metric are the number of mentions of a content item in the pages of a social network. Social networks are online communities in which community members can interact or transfer information and include chatrooms and forums such as Kendo World and Sword Forum International, as well as more complicated social networking sites such as MySpace.com.

Another characteristic that may be useful is that of the productivity of the publisher. For example, a publisher who produces only one work in his lifetime may not of very much interest to third parties regardless of how popular that one work is. However, a publisher that has created many popular works in over a period of time is generally believed to be more likely to create new popular works in the future and, thus, be of more interest to marketers, advertisers, corporate sponsors and distributors than the less productive, but still popular, publisher. Thus, publisher data may be collected that will be used in metrics that attempt to quantify the productivity or likely future productivity of the publisher. Such productivity indicative data may include number of content items associated with the publisher, the temporal distribution of the release dates of the content items, and the age of the publisher.

Publisher data include information for each content item associated with the publisher collected from one or more sources. Such information may include any data indicative of the popularity, distribution, delivery or use of a content item such as number of views by user, number of downloads, number of plays, number of mentions in news media articles, chat rooms, weblogs, etc., number of links linking to the content item, and revenues from advertising associated with a content item. Each type of data, then, corresponding to a different metric for the quality, popularity, and productivity of a content item or publisher as well as data that can be used in metrics for forecasting changes in the quality, popularity and productivity.

The type and quantity of data that can be used for publisher data is limited only by the ability of the identification system to obtain and store the data. However, it is recognized that some types of data, whether used directly as a metric or in a more complicated metric, may be more accurate or useful in identifying different characteristics of a content item or publisher. That is, some types of data may be leading indicators of popularity, such as mentions in MySpace listings among 8-12 year olds, reviews by certain known reviewers, number of internet searches on a specific search engine, or number of downloads to a specific type of device such as an iPod, while other metrics may be lagging indicators of popularity such as number of mentions in main stream media articles or advertising revenue. Thus, the system may distinguish between the types of data by developing complicated metrics that incorporate different types of data in an attempt to quantify one or more characteristics.

The collection operation 104 may be performed continuously, for example actively through the use of network searching tools such as web crawlers, passively from the receipt of data from publishers, or both. Alternatively, the collection operation 104 may be performed periodically such as the periodic searching of a search index for any new information related to known content items of known publishers.

In an embodiment, the collection operation 104 and the identification operation 102 may be combined with a general data gathering operation in which the network is continuously being investigated and the data obtained from the investigation is compared to the previously known data in order to identify new publishers, new publisher data, and changes in publisher data. The collection operation 104 may include taking periodic “snapshots” of each metric tracked by the system. In an embodiment, each snapshot then corresponds to the specific metric and its value at the time of the snapshot or its difference between the previous snapshot or some other reference point. Thus, the publisher data may be used to track the changes in each metric over time.

In an embodiment, the collection operation 104 may include periodically or occasionally accessing a ratings information database, that may be associated with or maintained by the identification system or by an independent ratings authority, and retrieving any new ratings posted into the database since the last access. The new ratings are then added to the system's pool of publisher data. For example, in an embodiment the identification system may access the ratings information of Amazon.com as part of collecting ratings information on different books and music. Data from multiple data repositories may also be used. For example, ratings for music may be collected from the separate music ratings databases maintained by Amazon.com, Microsoft, and Yahoo! Alternatively, the identification system may use only one database of ratings information in order to reduce the complexity of conforming different ratings methods and data. The collection operation 104 may similarly access collect the other types of data, e.g., number of downloads, sales data, etc., from the appropriate database.

In an embodiment, however, some data will be generated by or known only to the identification system. One example of this proprietary publisher data is the number of content items associated with a given publisher. Another example of proprietary publisher data may be the exact identity of a publisher and that publisher's contact information. By maintaining the publisher's information as proprietary, publishers may be able to maintain a secrecy of identity while still being able to benefit from, and capitalize on, their popularity.

The identification system uses the publisher data to create a ranking of each individual publisher known to the system in a ranking operation 106. The ranking operation 106 may be performed periodically or in response to new publisher data being received. The ranking operation 106 may include detailed statistical and mathematical analyses of the metrics using predetermined formulae. In addition, the formulae used to generate the ranking may be actively adapted over time to improve the ability of the ranking operation 106 to quickly and effectively identify new leaders and talent based on the available publisher data.

As will be discussed in greater detail below, the ranking operation 106 may be performed for each publisher and also may be performed to generate different rankings for a publisher within different market segments, categories or scopes. Scope, as used herein, means an identifiable market segment or subset of a community, or sub-classification of content items. For example, a music artist may be very popular within the known community of bluegrass listeners but not popular with the community of heavy metal listeners. As another example, a restaurant reviewer may be very popular with a specific demographic (e.g., single, 21-30 year old college students and graduates) within a specific geographic area (e.g., San Francisco) but not popular outside of that geographic region or demographic. In addition to the potentially huge variety of different market segments, community subsets and content item sub-classes, there may be an overall scope that includes everyone in the known community and for all content items.

The ability to determine different rankings within different scopes relies of the range and depth of publisher data available to the identification system. Thus, for each metric tracked by the system, the publisher data may include data related to each scope and the metric for that scope. For example, the metric of consumer ratings may be further augmented by identifying each consumer associated with each rating and determining which consumers are associated with which scope. If the identification system has access to substantial amounts of different types of interrelated data, the scope may be determined dynamically as part of the ranking operation 106. For example, when ranking a publisher the ranking operation 106 may dynamically attempt to identify scopes for which the publisher is highly ranked based solely on the publisher data available and the relationships found within the publisher data. If, for example, the identification system has access to consumer ratings of content items and the demographic information (e.g., age, sex, education, geographic region, favorite music types, etc.) related to each consumer that generated each of the ratings, then the identification system can use the available data to rank the publisher within different consumer scopes.

Alternatively, the ranking operating 106 may use the categories of the content items in order to generate a ranking by content item scope. In this embodiment, each content item may be associated with one or more categories, e.g., a song may be associated with bluegrass, country and folk at the same time. Such content item categorization may be provided by the publisher or by a third party, such as a reviewer, and, as discussed below, may be noted upon the initial indexing of the content item by the system and may or may not be subject to revision over time. Over time, as the publisher creates content items that are categorized differently, the data may be able to indicate which content item scope (e.g., which category of music) the publisher is most popular in.

The ranking operation 106 may analyze the publisher data to identify the scope for which the publisher has the highest ranking. Alternatively, the ranking operation 106 may also attempt to identify scopes for which the publisher has a rank higher than a given threshold.

Depending on the analyses performed during the ranking operation 106, the rank may be indicative of one or more different attributes of the publisher. For example, in an embodiment the analyses create a rank indicative of the potential of the publisher to increase in popularity in the near future within a given scope. In another embodiment, the analyses may create a rank indicative of the potential of the publisher to generate significant advertising revenue within a given scope. In yet another embodiment, the analyses may create a rank indicative of the potential of the publisher to reach a wide audience within a given scope. Other attributes are also possible including, for example, long term popularity, long term notoriety, potential for future content item sales, and potential to create future content items that will be popular. The predictive ability of the ranking operation 106 is limited by the publisher data and the ability of the analyses performed to accurately predict the future from the current data.

In an embodiment, the output of the ranking operation 106 is a rank/scope pair. In another embodiment, the output of the ranking operation 106 is the identification of a scope within which the publisher has met some minimum ranking threshold. Rankings may be absolute or relative to other ranked publishers within the scope.

The ranking operation 106 may also include an evaluation of the popularity trend of the content items of a publisher by including in the evaluation data describing how the publisher data have changed over time.

After the ranking operation 106 has identified one or more ranks for the publisher within at least one scope, an analysis operation 108 determines if the ranked publisher is to be identified as a leader or talent within that scope. As mentioned above, this may include comparing the rank with a threshold or comparing the rank with other ranked publishers within the scope. One skilled in the art will realize that the types and forms of analyses performed to rank the publisher will dictate different conditions (e.g., a threshold score, a relative score among other publishers within the scope, or some other measure or condition) suitable for determining whether a publisher should be identified as talent. An example of one method of ranking publishers to identify talent is provided below.

If the analysis operation 108 identifies a publisher as talent, the identification system may automatically generate a notification in an identify talent operation 110. This may be in the form of a report to a user that lists leading publishers recently identified by the system. The report may include such information as the publisher's information, the scope within which the publisher is a leader, and the ranking. The user is then able to contact the publisher in order to retain the publisher's services or otherwise contract with the publisher for some purpose. Alternatively, the user may then act as a broker to match the newly identified talent with advertisers or other third parties interested in the scope of the identifier leader.

In an automated system, for example, highly ranked publishers and their pertinent information including scope and content items may be posted or made available to potentially interested parties. For example, in the same way advertising words are sold by search engines, the publisher identification system could alert members to up and coming talent within specified scopes and allow the members to bid or otherwise pay to engage the talent. In an embodiment, a member of the publisher identification system may request to be alerted to new talent within a scope. The system may then actively generate a list of current talent based on the scope definition and the current data. This list may or may not be provided to the requesting member. Subsequently, as additional publisher data accumulates and is analyzed and used to rank publishers, periodic reports may be provided to the requesting member. The report may identify new talent and/or leaders whose rankings are improving relative to other leaders. The report may also include or link to one or more of the content items for each identified leader so that the requesting member has easy access to the publisher's material. If based on the requesting member's review of the information, the requesting member decides to retain a leader identified on the list the identification system may further assist with this transaction.

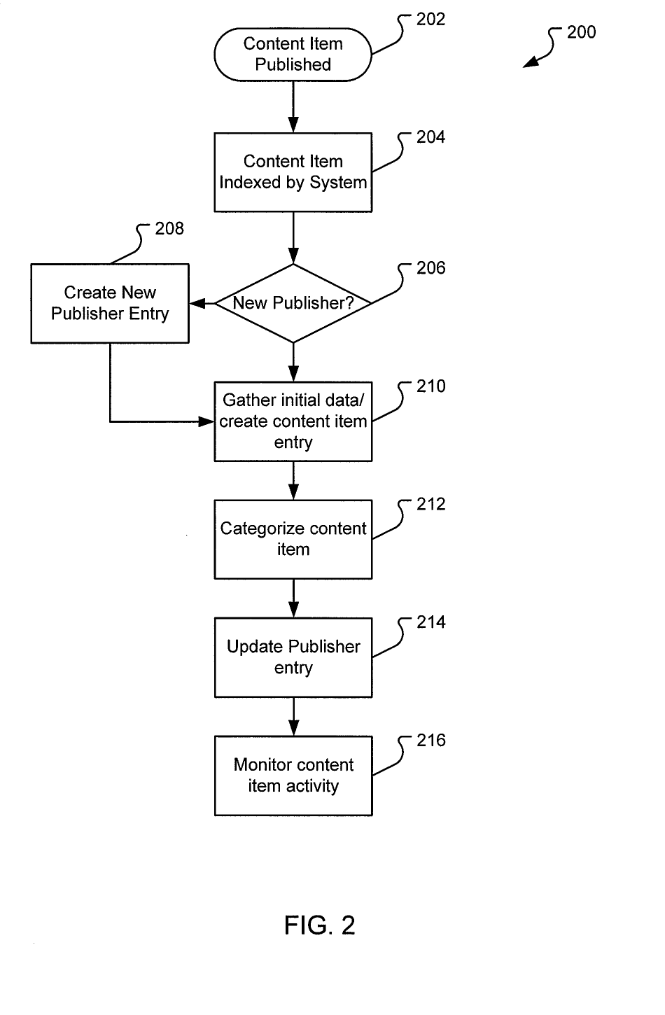

FIG. 2 illustrates an embodiment of a method for automatically obtaining publisher data from a network such as the Internet. The method 200 starts with the publication 202 a new content item by a publisher. As discussed above, the publication operation 202 may consist of making a new file accessible on a computer network such as the Internet. Alternatively, the publication operation 202 may include a more traditional form of publication such as the publication of book, movie or magazine in hard copy.

In the method 200, the talent identification system becomes aware of the new content item in an encounter operation 204. In an embodiment, the talent identification system includes a search engine, web crawler or some other automated system that either periodically or continuously searches networks, such as computer networks like the Internet, for newly published content items, such new content items then being identified in an index in a data store along with information about the content item. In an alternative embodiment, new content items may be registered with the talent identification system when published or as part of the publication of the new content item, thus combining the publication operation 202 and the encounter operation 204.

Based on the information associated with the content item, the system determines if the publisher of the content item is a publisher that is new to the system or that is already known to the system in a determination operation 206. If the publisher is new, a new publisher entry may be created in the index in a create new publisher operation 208. If the publisher is unidentifiable from the data available, a “dummy” publisher may be assigned to the new content item. This information may then be revised at a later date when the actual publisher is determined.

Regardless of the whether the publisher is new to the system or not, the system also gathers and stores the initial data in a gather initial data operation 210. The information collected in the gather initial data operation 210 may include any information identifying the publisher of the new content item (such as information in the metadata of the new content item, the content item's network location, information stored with the content item identifying its publisher, etc.) and information identifying the content item itself (such as the content item's network location, a content item identifier, a content item “fingerprint,” or some other way of uniquely identifying the content item). In an embodiment, such initial data may be considered “primary data” in that it may be obtained from inspection of the content item and/or was information initially generated by the publisher about the content item. This is opposed to secondary data, which may be considered information about the content item generated by consumers or parties other than the publisher. For example, weblogs are often published as RSS feeds and the RSS feed specification allows publishers to include many different kinds of primary data. Metadata contained within media files and HTML pages are another type of primary data. The gather initial data operation 210 may also include creating a new content item entry in a database or content item index.

In an embodiment, the system may categorize the content item based on the primary information in a categorization operation 212. Such a categorization operation 212 may categorize the content item simply by type, e.g., audio file, video file, book, text file, weblog, review, restaurant, etc. Alternatively, a more detailed categorization may be done such as a bluegrass song, a horror movie, a current events book, a right-wing political weblog, a product review, a sushi restaurant, etc. In an alternative embodiment, the categorization operation 212 need not be included in the method 200.

After the primary data has been stored, the publisher entry may be updated in an update operation 214. The update operation 214 associates the publisher with the new content item so that in future analyses of the publisher data, the new content item's primary and secondary data are considered. In an embodiment, publisher data may be stored separately and generated from any associated content items' data. In an alternative embodiment, content item data may be stored in one location and the publisher data may be generated as needed from the content items and content items' data.

The system then monitors the network for new secondary data related to each known content item in an ongoing monitoring operation 216. As discussed above, the secondary data collected may include such things as reviews for each content item collected from one or more sources; rating information including any data indicative of the popularity, distribution, delivery or use of a content item such as number of views by user, number of downloads, number of plays, number of mentions in news media articles, chat rooms, weblogs, etc., number of links linking to the content item, sales information, and revenues from advertising associated with a content item.

Note that each item of secondary data may be associated with additional secondary data. For example, an individual rating of a content item is secondary data and the personal information associated with the review that supplied that rating is additional secondary data that is associated with the content item.

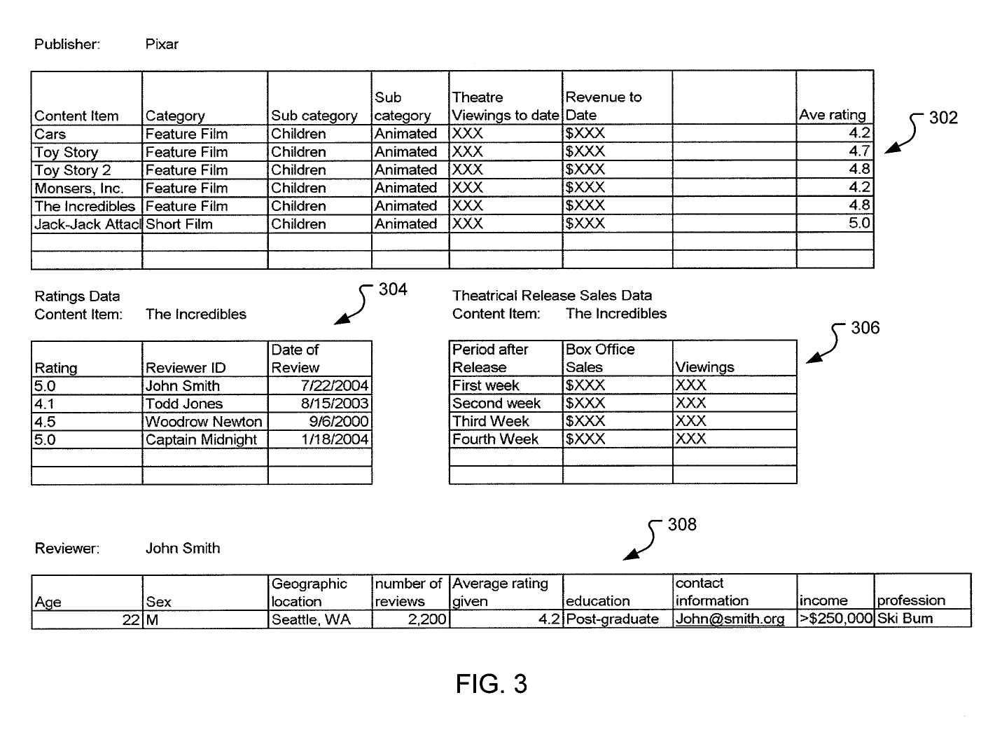

FIG. 3 illustrates one embodiment of a publisher data scheme that may be used in a talent identification system. In FIG. 3, the film company Pixar is used as an example of a publisher for discussion purposes. One skilled in the art will recognize that the systems and methods described could be equally adapted to any publisher of any type of content, such as for example, book authors, reviewers, music artists, etc.

In the embodiment shown, a set of publisher-level data, illustrated as a table 302, for each publisher may be created. The set may include a list of content items associated with the publisher. Each content item may be further associated with one or more categories and sub-categories as shown. This information may be used to develop different scope rankings for the content items and for the publisher. In addition, for each content item, various summary data may also be maintained. In the embodiment shown, there are data that may be used as metrics for content item popularity such as revenue and total number of viewings. The embodiment further includes data related to the quality of the content items, e.g., the average rating of the content item. This data may be maintained separately, or may be derived from content item-level data discussed below.

FIG. 3 also includes content item-level data, illustrated as two tables 304, 306. Content-item-level data are data that provide more detail about the quality and popularity of the individual content items. In the embodiment shown, a set of quality related data is displayed in a first content item table 304 for the content item “The Incredibles”. In the example shown, the data include individual ratings as well as the date of the rating and the reviewer that rated the content item.

A set of popularity related data is displayed in a second content item table 306. In the example shown, box office sales and number of viewings are provided broken down over time. Such data can then be used to determine a popularity of the content item relative to other content items and may also be used to identify popularity trends for the content item.

FIG. 3 further includes consumer-level data, illustrated as a table 308. Ultimately, content items are popular with, and their relative quality is determined by, individuals. To the extent possible, the talent identification system uses the information available for reviewers, purchasers, and other consumers of the content items to better identify talent and define the best scope for the talent. In the example shown, the consumer-level data for each consumer associated with a content item include such demographic information as age, sex, geographic location, education, income and profession. In addition, other information may be included such the number of ratings provided by the individual and the average rating provided by the individual over time. Although not shown, additional information such as data concerning consumption habits, personal information on interests provided by the individual as part of a profile, historical purchases, etc. may be included as well. Such information may be useful for metrics to determine a scope of popularity of content items and publishers with the consumers.

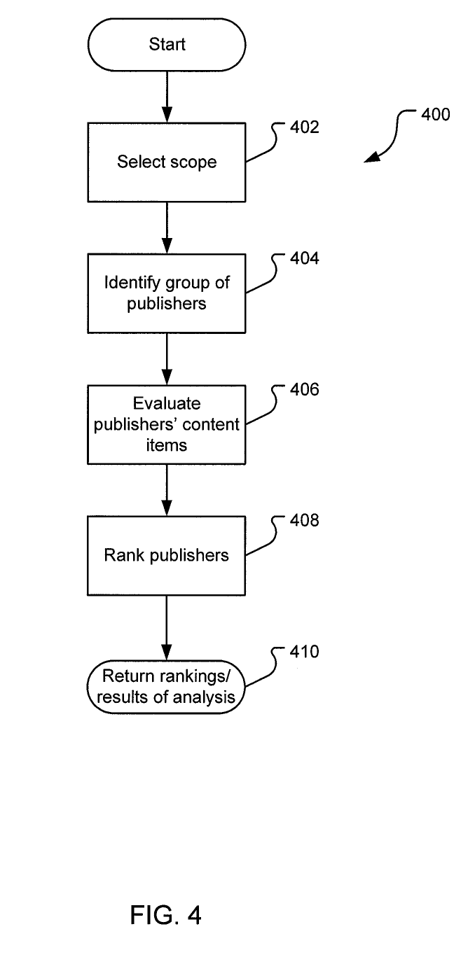

FIG. 4 illustrates an embodiment of a method of analyzing a pool of publisher data for a group of publishers to identify talent within a scope. The method 400 presumes that the necessary data has already been collected, such as by the method 200 described above with reference to FIG. 2. The method may be performed automatically, such as periodically or in response to the occurrence of some triggering condition, such as new publishers or content items being identified. Alternatively, the method 400 may be performed in response to a request from an advertiser or other party that desires to find talent in a scope.

In the embodiment shown, method 400 begins with a selection of a scope in a scope selection operation 402. The scope selected may be a content item scope, such as animated childrens' feature films, San Francisco-area restaurant reviews, bluegrass songs, or books on existentialist philosophy. If the method 400 is being performed in response to a request of some kind, e.g., a request from an advertise to identify or rank talent within a certain scope, the scope may be dictated by or in the request. For example, an advertiser may access a interface web page through which the requester can view the different scopes and make a selection.

After the scope has been selected, the group of publishers that have published content items within the scope are identified in an identification operation 404. The identification may be performed based on publisher data known to the talent identification system. For example, if the scope selected is a music genre, such as bluegrass songs, the genre information contained in the publisher data may be inspected in order to determine the subset of content items that are bluegrass songs and, from that information, then generate the list of publishers known to the system as bluegrass song publishers.

In the embodiment shown, after the publishers have been identified, then some or all of the publishers content items within the scope are evaluated in an evaluation operation 406 based on some predetermined algorithm. Examples of such algorithms are discussed in greater detail below.

In the embodiment shown, each publisher is then ranked within the group of publishers in a ranking operation 408. The ranking operation 408 may include ranking each publisher in a different capacity, such as likelihood of creating new content items in the future, popularity likelihood, likelihood of losing popularity, etc. In an alternative embodiment, some way other than ranking may be used to compare the publishers, such as identifying the publishers in different categories based on the results of the analysis in the evaluation operation 406. For example, publishers may be categorized as “recognized leaders in the scope,” “new talent that are increasing in popularity but still relatively unknown,” “publishers with decreasing popularity,” etc.

After the comparison has been performed, the results are then returned to the requesting entity in a return results operation 410. If the method 400 is performed automatically, the return results operation 410 may be performed only when a change from previous rankings is identified. This allows the system to generate results automatically in response to new publisher data that actually represents a change that is potentially of significance to the system's operator.

The method 400 may be used by the system's operators to broker new talent to potential advertisers in a manner similar to advertisement words are brokered currently to advertisers by search engines. An advertiser may “bid” on providing advertisements in or associated with content items or publishers with a selected scope.

As part of determining the ranking of a publisher, the system may attempt to objectively gauge the change in popularity (e.g. quantify popularity trend) of each of the publisher's content items from the available data. For the purposes of this disclosure, the rate of change in popularity of a content item will be referred to as its “velocity”. A content item will be considered to have a high velocity if the available data indicates that the content item is rapidly becoming more popular over time. A content item will be considered to have a low or negative velocity if it is becoming less popular depending on how the velocity is calculated.

One embodiment of a method of calculating a content item's velocity uses publisher data including a) data indicative of quality such as the average rating of the content item and b) data indicative of popularity such as the number of downloads (or alternatively purchases, revenue or viewings) over a given period of time. In the embodiment, the popularity data over time is fit to a mathematical curve, such as an exponential equation where the number of downloads in a week (y) is a function of time (t) and fit to the curve y=A t^{B}, and the coefficients A and B are determined by calculation from the data. The coefficient B will be larger if, over the period of time, the general trend in the number of downloads is increasing. The velocity is then determined via multiplying the quality data by the coefficient B. Thus, such a calculation could be represented by the formula:

content item velocity=[average ratings]×[B]

One skilled in the art will recognize that the example calculations provided above are but one example of a simple method of using quality and popularity data to statistically identify trends in the data and that there are many different methods and calculations for statistically analyzing such data to identify trends and make predictions. For example, the popularity data could be fit to a different mathematical formula, such as a quadratic equation, and the coefficients determined used in a different velocity calculation. Any such linear regression or non-linear regression analysis techniques may be applicable, whether now known or later developed, to analyze the various publisher data and generate some comparison, ranking or relative identification of publishers within the selected scope.

In addition, the example provided above includes only one type of quality data and one type of popularity data. As discussed above, a talent identification system may have access to many different types of both quality data and popularity data. Furthermore, some data may be useful both as quality and as popularity indicators.

In addition, to calculating a content item velocity, the above method could be further adapted to be applied directly to a publisher in many different ways to calculate a publisher's velocity. In an embodiment, for example, a publisher's velocity may be the average of the velocities of the publisher's content items within a selected scope, thus being based on quality and popularity data known to the system of the publisher's work.

Furthermore, in another embodiment, the publisher's velocity in addition to being based on the quality and popularity data for that publisher's content items, may also take into account the relative productivity of the publisher of content items. For example, the publisher's velocity could be the sum of each of the publisher's content items within a scope. Such a calculation would then give higher scores to more prolific publishers within the scope. Alternatively, an average content item velocity could be calculated for each publisher and then multiplied by the number of content items within the scope for that publisher.

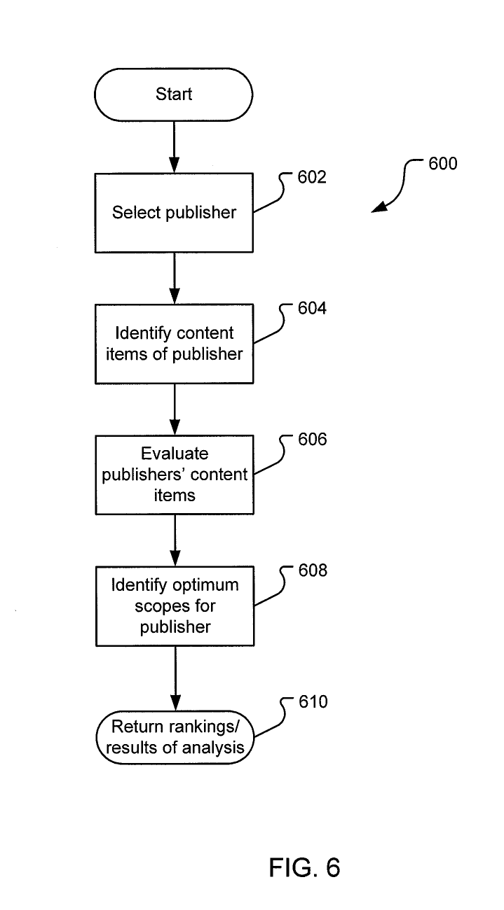

FIG. 6 illustrates another embodiment of method for automatically identifying talent. In the method 600 shown, the system identifies talent by reviewing the publisher data available to the system and finds the scopes of each publisher for which the publisher has a ranking. One aspect of this method is that a publisher may be identified as talent in some scopes that the publisher was previously unaware of, as the scopes may be determined from the data created by the consumer rather than the data provided or tracked by the publisher.

The method 600 starts when a publisher is selected in a publisher selection operation 602. The publisher selection may occur as a result of a user input, e.g., a publisher interfacing with the system in order to obtain a popularity report. Alternatively, the method may be performed periodically or occasionally for all publishers known to the system.

After the publisher is selected, the content items associated with the publisher are identified in an identify content items operation 604. In this operation 604, all the content items of the publisher, regardless of categorization or scope, are identified so that they can be analyzed.

The publisher data available for each content item is then analyzed in an analysis operation 606. The analysis operation looks at all types of available data including extended data. For example, different quality data may be identified for each content item by demographic by looking at how ratings break down by reviewer. Thus, songs may be determined to be more popular in a geographic region or with a specific sex or demographic segment from quality data that includes demographic information on the consumers that are providing the quality data. In another example, different popularity data may also be identified, for example based on data that identifies who is downloading the content item and their demographic information.

After the data has been collected and analyzed, the system may then optimize the ranking of each publisher in order to find the scope or scopes for which the publisher is most popular. In addition, if an absolute measurement is used to quantify a publisher's popularity or talent score, the optimize operation 608 may seek to identify those scopes within which the publisher has a talent score greater than some predetermined threshold.

In order to make the analysis less susceptible to outlying data points, the analyze data and identify optimum scopes operation may include requiring a minimum number of data points before identifying a scope. For example, a minimum of 5000 different consumers may need to rate a content item within any given geographical region before the system will identify the publisher or the content item as being associated with that scope or having a velocity or other ranking within that scope. Thus, as a publisher penetrates a market, the publisher may begin to show a velocity a plurality of different scopes.

After the analysis is performed and the publishers rankings by scope are identified, the information is presented in a return results operation 610. In an embodiment, these results may be provided for a fee to the publisher. In another embodiment, these results may be provided to potential investors or other parties interested in the publisher's performance.

Publisher-specific information, particularly regarding scopes for which the publisher has a good (or bad) publisher velocity, will also be of interest to the publisher as well as to potential sponsors or business partners of the publisher. The identification of new scopes within which the publisher is popular will allow the publisher to focus marketing and sales efforts more effectively. In addition, such identification may allow the publisher to tailor future content items to previously unrecognized market segments.

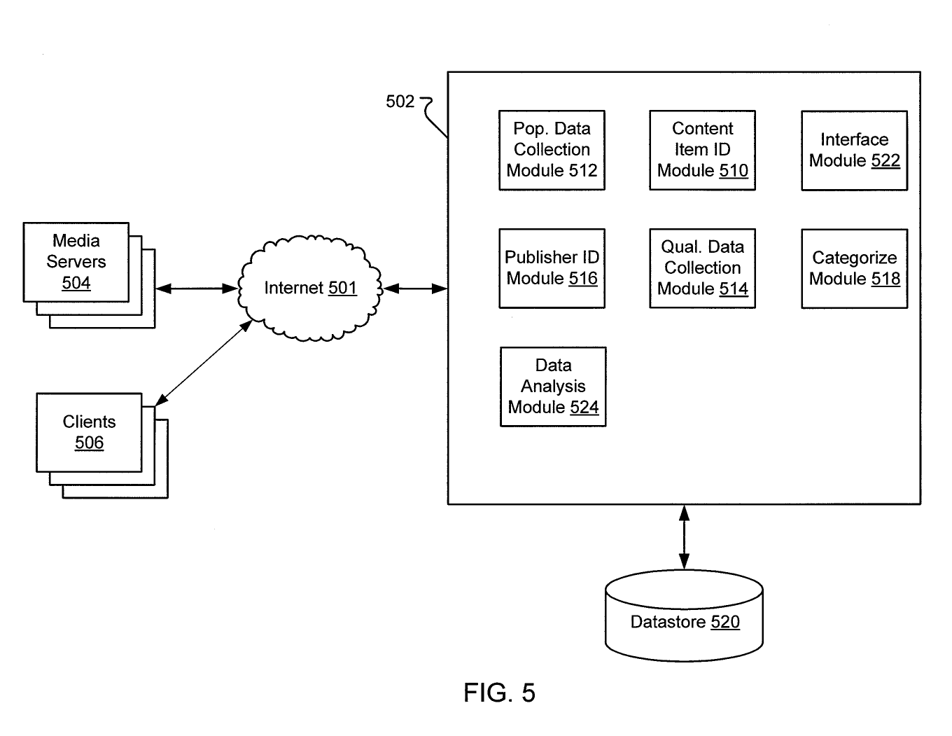

FIG. 5 illustrates a functional block diagram of a system for identifying leading publishers of content. In the embodiment shown, the system 500 includes a talent identification server 502 connected via a network 501, e.g., the Internet 501, to one or more computing devices including media servers 504 and client computers 506.

In the embodiment shown, a computing device such as the client 506 or server 504, 502 typically includes a processor and memory for storing data and software as well as means for communicating with other computing devices, e.g., a network interface module. In an embodiment, computing devices are further provided with operating systems and can execute software applications in order to manipulate data. One skilled in the art will recognize that although referred to in the singular, a server may actually consist of a plurality of computing devices that operate together to provide data in response to requests from other computing devices. Thus, as used herein the term server more accurately refers to a computing device or set of computing devices that work together to respond to specific requests.

In a computing device, local files, such as media files or raw data stored in the datastore 520, may be stored on a mass storage device (not shown) that is connected to or part of any of the computing devices described herein including the client 506 or a server 504, 502. A mass storage device and its associated computer-readable media, provide non-volatile storage for the computing device. Although the description of computer-readable media contained herein refers to a mass storage device, such as a hard disk or CD-ROM drive, it should be appreciated by those skilled in the art that computer-readable media can be any available media that can be accessed by the computing device.

By way of example, and not limitation, computer-readable media may comprise computer storage media and communication media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

In the architecture shown, media servers 504 may be servers that maintain information about content items, that maintain content items themselves, or both. One common example of a media server 504 are servers that provide information such as servers that provide traditional news services (e.g., CNN.com, abcnews.com, yahoo.com, etc.) and servers that provide public commentary such as weblogs. While the individual articles may maintain data concerning a content item, each article and video on the news website may be considered a separate content item.

Another example of a media server 504 is a social networking server, such as myspace.com. Such social networking servers often include pages and other content items created and posted by the member of the social network. Again, such pages may be individual content items and may also include publisher data useful to and retrievable by the talent identification server 502.

Yet another example of a media server 504 is a commercial storefront server, e.g., servers associated with Amazon.com, ebay.com and other online retailers, that offers products, which may be content items, for sale. Often, these servers include product-specific information and consumer reviews and product ratings which may be used as publisher data by the talent identification server 502.

In addition to servers which maintain, in some form or another, publisher data, the talent identification server 502 may also be adapted to receive publisher data directly from client computers 506 operated by publishers. As discussed above, in an embodiment a publisher may access the talent identification server 502 and register the new content item or otherwise provide publication data directly to the server 502. Such registration may be part of a process of publishing the content item, e.g., the content item is published by the server 502 or through the server 502, or independently provided in order to make certain that the system 500 has the most up to date information.

The architecture further includes the talent identification server 502. The talent identification server 502 may be one or more servers that are independent from other computing devices on the network 501. Alternatively, the talent identification server 502 may also operate as a media server 504 such that the talent identification functions and the media server functions are performed ostensibly on the same computing device. One benefit of having a server that performs combined functions is that the talent identification server 502 will have complete knowledge of the information on the associated media server 504, including many types of information that are normally not publicly available, such as number of downloads, page requests, search queries, etc.

For example, as discussed above the talent identification server 502 may be implemented as part of or in tandem with a social networking server 504. In that embodiment, whenever a new content item, such as a review, weblog, video, playlist, etc., is posted to the media server 506, the associated talent identification server 502 is automatically made aware of the new information and such publisher data is immediately collected by the server 502. In addition, if the social networking server 504 includes a forum or other chat or instant messaging functionality the talent identification server 502 may then inspect instant messages for references to content items, such references then being used as publisher data.

In FIG. 5, the various modules of the talent identification server 502 are presented with reference to some of the functions they perform. In the embodiment shown, the talent identification server 502 includes a content item identification module 510; a popularity data collection module 512; a quality data collection module 514; a publisher identification module 516; a content item categorization module 518; a datastore 520 containing publisher data; an interface module 522 and a data analysis module 524. In alternative embodiments, more or less modules may be used in order to perform the functions of that embodiment.

The content item identification module 510 performs the function of identifying content items, either by actively “crawling” the network for new content items or by receiving new data via the interface module from publishers. Thus, in an embodiment the content item identification module 510 may include a web crawler, such as those employed by search engines like Google.com or Yahoo.com to index information on the network 501. Alternatively, the content item identification module 510 may have access to an index maintained by an independent web crawler.

The content identification module 510 may also interface with the categorization module 518 when a new content items is identified. In an embodiment, upon identification of a new content item, the content identification module 510 provides an initial set of data to the categorization module 518 so that the categorization module 518 may create an initial category for the content item. The categorization module 518 may periodically recategorize content items based on publisher data. Alternatively, the categorization module 518 may provide only categorization data obtained from the publisher.

The popularity data collection module 512 is responsible for collecting the popularity data necessary for the analysis module 524 to generate the ranking or other results of the system 500. In an embodiment, the popularity data is a predetermined set of data obtained from predetermined locations on the network. Thus, the popularity data collection module 512 may be required to periodically or occasionally retrieve or access specific data from specified locations. In a combined embodiment in which the talent identification server 502 is implemented with a media server 504, some or all popularity data may be obtained directly from the datastore 520 that supports the media server functions.

The quality data collection module 514 is responsible for collecting the quality data necessary for the analysis module 524 to generate the ranking or other results of the system 500. In an embodiment, the quality data is a predetermined set of data, such as ratings data, obtained from predetermined locations on the network. Thus, the quality data collection module 514 may be required to periodically or occasionally retrieve or access specific data from specified locations. In a combined embodiment in which the talent identification server 502 is implemented with a media server 504, some or all quality data may be obtained directly from the datastore 520 that supports the media server functions.

The data collection modules 512, 514 may actively retrieve data and store that data in the datastore 520 for later use by the data analysis module 524. Alternatively, the data collection modules 512, 514 may retrieve data when such data are needed by the data analysis module 524 so that publisher data, as a separate set of data independent from the original data sources, are not stored by the data collection modules 512, 514.

The datastore 520 may be dedicated to receiving, storing and maintaining publisher data gathered by or received by the data collection modules 512, 514. Alternatively, as in a combined media/talent identification server embodiment, the datastore 520 may collect and store data that support the media server functions; the publisher data then being considered only that portion of data of used by the talent identification system. In this way, publisher data need not be stored twice in separate locations (i.e., on the source media server datastore and on the talent identification server's datastore 520) but may be common and shared between the media and talent identification systems. For example, in an embodiment, the datastore 520 may be a relational database that is maintained separately on a database server and shared between multiple computing devices and systems.

Thus, in an embodiment, the datastore 520 may be shared by a search engine, a social network website, a music archive and virtual storefront, a news website and the talent identification system. Each system sharing the datastore 520 may be adding data to the datastore 520 in a format that is known to the other systems so that data from any one source may be used by the talent identification system for the identification of talent.

The system further includes a publisher identification module 516. The publisher identification module 516 is adapted to analyze data from and related to content items in order to associate one or more publishers with each content item. As discussed above, if a publisher can not be identified, a new publisher ID may be assigned to the content item, which may then be revised later as new data on the publisher becomes available. Thus, the publisher identification module 516 may actively collect and check publisher information over time.

The system shown also includes an interface module 522. In an embodiment the interface module 522 allows a publisher to register a new content item with the talent identification server 502. The interface module 522 may provide a web page to clients 506 over the network 501. Alternatively, the interface module 522 may be adapted to receive information from a system administrator. In yet another embodiment, the interface module 522 may interact with other computing devices, such as a media server 504, automatically so that when new content items are posted to or published on the media server 504, the information is automatically delivered to the talent identification server 502.

In addition, the interface module 522 may also provide an interface to third parties that wish to be alerted when new talent are identified by the system. In an embodiment, the interface module 522 may provide a web page that allows third parties to access the system and have searches for talent in specific scopes performed. Alternatively, the interface module 522 may generate notifications to third parties when new talent are identified within specified scopes. The interface module 522 may then receive information regarding scopes of interest and contact information for the third party.

Information, such as results, generated by the talent identification server 502 may be provided to third parties for a fee. In addition, such information may be provided as part of an paid ongoing service to members of industries that are continuously on the look out for new talent. For example, a record label that is continuously on the look out for new recording artists may purchase a subscription to periodic popularity rankings within specific scopes. A bluegrass record label may wish to see the publisher rankings for all publishers of bluegrass songs each week. Alternatively, a third party may wish to be alerted only to new publishers with high publisher velocities or new content items with high content item velocities within a certain scope. The interface module 522 may include maintaining and managing billing and membership information. The module 522 responsible for propagating the requested information to the appropriate party and issuing bills as necessary depending on the contract. In an embodiment, the interface module 522 may allow a third party to set up such talent watch and reporting service directly through the interface provided.

The system further includes an analysis module 524. The analysis module 524 includes the logic and algorithms necessary for creating the rankings and or determining the velocity of publishers and content items within different scopes. The specifics of the logic and algorithms may be adjusted over time to create more accurate results. The module 524 may include an optimization routine that compares past results with current results in light of the new information in order to identify metrics and data sources that are potentially better predictors of popularity. The logic may then be revised to place more value on future data from that data source and less value on data sources that are not consistent predictors of popularity or quality.

Those skilled in the art will recognize that the methods and systems of the present disclosure may be implemented in many manners and as such are not to be limited by the foregoing exemplary embodiments and examples. In other words, functional elements being performed by a single or multiple components, in various combinations of hardware and software or firmware, and individual functions, can be distributed among software applications at either the client or server level or both. In this regard, any number of the features of the different embodiments described herein may be combined into single or multiple embodiments, and alternate embodiments having fewer than or more than all of the features herein described are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, and those variations and modifications that may be made to the hardware or software or firmware components described herein as would be understood by those skilled in the art now and hereafter.

While various embodiments have been described for purposes of this disclosure, various changes and modifications may be made which are well within the scope of the present invention. For example, the systems and methods described could be adapted to the sale of products such as bicycles and include such data as number of racers using each brand, sales amount, results of manual interviews or random polling of consumers. Furthermore, embodiments of the systems and methods described herein could be adapted to work with any data source associated with any commercial enterprise in order to identify consumer habits and trends in the use of resources. For example, the usage trends of different types of cars within a car rental agency could be automatically analyzed in order to identify how best to purchase cars in the future based on popularity and quality data.

Numerous other changes may be made which will readily suggest themselves to those skilled in the art and which are encompassed in the spirit of the invention disclosed and as defined in the appended claims.

What is claimed is:

1. A method for identifying talent comprising:
identifying at least one content item associated with a publisher;
retrieving first data indicative of the quality of each content item;
retrieving second data indicative of the popularity of each content item;
ranking the publisher based on the first data and the second data of each content item; and
based on the results of the ranking operation, identifying the publisher as talent.

2. The method of claim 1 further comprising:
determining a popularity trend for each content item based on the retrieved second data; and
ranking the publisher based on the first data and the popularity trend.

3. The method of claim 1 further comprising:
independently categorizing each content item into one or more categories; and
wherein ranking the publisher includes separately ranking the publisher in each category associated with the content items of the publisher

4. The method of claim 1 wherein monitoring first data further comprises:
accessing ratings information containing ratings of the quality of content items on a network; and
retrieving the ratings information associated with each content item.

5. The method of claim 1 wherein monitoring the second data further comprises:
periodically accessing consumption data on a network; and
retrieving the consumption data associated with different periods for each content item.

6. The method of claim 1 wherein monitoring the second data further comprises:
retrieving one or more types of consumption data selected from a number of downloads, a number of purchases, a sales number, a revenue number, a number of viewings, a number of mentions in a news media report, and a number of mentions in a social network from at least one location on the network.

7. A system for identifying publishers comprising:
a popularity data collection module adapted to access popularity data on a computing network, the popularity data including data indicative of the popularity of a content item;
a quality data collection module adapted to access quality data on the computing network, the quality data including data indicative of the quality of the content item; and
an analysis module adapted to generate a content item velocity based on the popularity data and the quality data.

8. The system of claim 7 wherein generation of the content item velocity includes multiplying an average quality rating with a statistical representation of the content item's popularity.

9. The system of claim 7 further comprising:
a content item identification module adapted to identify new content items on a network;
a publisher identification module adapted to identify a publisher of the each content item identified by the content item identification module;

10. The system of claim 9 wherein the analysis module is further adapted to generate a publisher velocity based on the popularity data and quality data associated with at least one content item of the publisher.

11. The system of claim 10 wherein the analysis module is further adapted to generate a publisher velocity based on the popularity data and quality data associated with each content item of the publisher.

12. The system of claim 9 wherein the analysis module is further adapted to generate a plurality of different publisher velocities for each publisher based on differences in the popularity data and quality data for the publisher's content items.

13. A method of selecting a first publisher from a group of publishers of content items within a scope, the method comprising:
collecting first data indicative of the popularity of the content items, the first data collected from one or more locations on a network;
identifying the first data associated with content items for each one of the group of publishers;
analyzing the first data for each one of the group of publishers to generate results indicative of the relative popularity of each one of the group of publishers; and
selecting, based on the results, the first publisher.

14. The method of claim 13 further comprising:
wherein the results indicate that the first publisher is the most popular publisher of the group of publishers.

15. The method of claim 13 further comprising:
wherein the results indicate that the first publisher has a score greater than a predetermined threshold.

16. The method of claim 13 further comprising:
selecting the scope, the scope identifying either a subset of content items or a subset of first data; and
identifying the group of publishers as publishers associated with the scope.

17. The method of claim 13 further comprising:
collecting second data indicative of the quality of the content items, the second data collected from one or more locations on the network; and
wherein analyzing further includes analyzing the first data and the second data associated with content items for each one of the group of publishers to generate results indicative of the relative popularity of each one of the group of publishers.

18. The method of claim 17 further comprising:
collecting third data indicative of the productivity of each one of publishers in the group, the third data collected from one or more locations on the network; and
wherein analyzing further includes analyzing the first data, the second data and the third data to generate results indicative of the relative popularity of each one of the group of publishers.

19. The method of claim 13 further comprising:
analyzing the first data to generate a popularity trend for each publisher in the group; and
selecting the first publisher based on a comparison of the first publisher's popularity trend with the rest of the publishers' popularity trends.

20. The method of claim 13 further comprising:
selecting the scope; and
identifying the content items within the scope and wherein the group of publishers being the publishers associated with the content items within the scope.

21. The method of claim 17 wherein analyzing further comprises:
calculating, for each content item associated with a publisher, an average rating from the first data, the average rating representing an overall quality of content items associated with the publisher;
calculating, for each content item associated with a publisher, a representative measure of the change of popularity of the content item over time; and
multiplying the average rating and the representative measure to obtain a content item velocity associated with the content item.

22. The method of claim 21 further comprising:
generating a results indicative of the relative popularity of each one of the group of publishers based on the content item velocity of each content item associated with each one of the group of publishers.

23. A talent identification device comprising:
a processor;
a datastore accessible to the microprocessor containing quality data and popularity associated with content items created by publishers; and
a talent identification means for analyzing the quality data and popularity associated with content items created by publishers and identifying at least one of the publishers as being relatively more popular than the other publishers.
